(19) United States
(12) Patent Application Publication
(10) Pub. No.: US 2013/0073349 A1
(43) Pub. Date: Mar. 21, 2013

(54) Method for the Computer Aided Management of Vehicles

(71) Applicant: Joachim KOLLING, Eching (DE)

(72) Inventor: Joachim KOLLING, Eching (DE)

(73) Assignee: Bayerische Motoren Werke Aktiengesellschaft, Muenchen (DE)

(21) Appl. No.: 13/622,127

(22) Filed: Sep. 18, 2012

(30) Foreign Application Priority Data
Sep. 19, 2011 (DE) 10 2011 082 982.2

(51) Int. Cl. G07B 15/02

(52) U.S. Cl. 705/13

(57) ABSTRACT

An owned vehicle for use is registered at a management unit of a computer system as a rental vehicle. A first interface of the computer system that is accessible through registration, captures persons, approved by the vehicle owner, for a temporary use of the vehicle; a price model, specified by the owner, for the temporary use of the vehicle; and an operating area, defined by the owner. The operating area encompasses one or more demarcated areas, in which the vehicle may be parked by an approved person after the end of the temporary use. When an approved person is operating the vehicle, a data acquisition unit of the computer system receives telematically vehicle trip related data. An accounting unit determines, as a function of the vehicle trip related data and the price model for a predefined time for the respective approved person, an amount to be billed.

### CROSS REFERENCE TO RELATED APPLICATION

This application claims priority under 35 U.S.C. §119 from German Patent Application No. DE 2011 082 982.2, filed Sep. 19, 2011, the entire disclosure of which is herein expressly incorporated by reference.

### BACKGROUND AND SUMMARY OF THE INVENTION

The invention relates to a method for the computer aided management of the use of vehicles, which vehicles include, in each instance, a telematic unit for transmitting predefined data to a computer system and a keyless access and start system. Furthermore, the invention relates to a system for the computer aided management of the use of vehicles.

A vehicle rental system (so-called “car sharing”) is defined as the organized joint use of one or more vehicles. Classical car sharing is based on the concept that the vehicles of a car sharing organization are usually distributed throughout a city or over a larger location at parking lots that are rented on a permanent basis. The locations are often at junction points of the public transportation system (like railway stations, end stops of bus lines, etc.), where they are easy to reach by members of the car sharing organization. The pre-reserved vehicles are usually used to reach destinations that are also more distant from these junction points. In contrast to a classical car rental, it is also possible to use the vehicle for a short period of time or, more specifically, by the hour. Especially in urban residential areas, where a parking spot is not available for all vehicles, car sharing can decrease the strain on the parking spot situation. The drawback with the classical car sharing concept is the circumstance that both the duration of the use of the vehicle has to be specified in advance and also the vehicle usually has to be returned to the rented parking spot, from which the vehicle was picked up.

A number of systems are used for reserving the vehicles of a car sharing organization. The known solutions range from simple key boxes and manual reservation to highly complicated computer aided solutions. In the case of larger organizations, an automatic reservation is possible around the clock over the Internet or with a telephone computer. Similarly, the vehicles are often equipped with on-board computers that are automatically synchronized with the centralized server. The on-board computer releases a vehicle to the authorized person only for the reserved period of time. The purpose of this strategy is to render the reservation process more efficient. In addition, the aim is to prevent misuse of the system.

In addition to the classical car sharing, the so-called roadside car sharing (or flexible one way car sharing) has been recently set up in larger cities. In this system, the vehicles are not parked at fixed locations, but rather may be parked anywhere within a defined operating area of a city. Therefore, even one way trips are possible for a user. It is assumed that the vehicles are largely uniformly distributed throughout the urban area. The objective is that each participant can reach, if desired, a vehicle within, for example, a 15 minute walking period. Available vehicles can be located over the Internet, with a Smartphone application or by telephone and spontaneously rented or can be reserved a certain period of time in advance. The billing is a function of the time, so that a minute price covers the number of kilometers driven, the insurance and the parking in specifically marked areas. Such roadside car sharing systems are offered, for example, with Car2go of the company Daimler AG/Europcar and DriveNow of the company BMW AG/Sixt.

The acceptance of this mobile service has increased through the roadside car sharing program. However, it is limited to the operating area of the respective service provider. Therefore, residences in certain areas of the city or street blocks are no longer within the operating area and, therefore, cannot participate in the car sharing program. Moreover, inhabitants of smaller cities or towns cannot profit from the benefits of the roadside car sharing program.

The object of the present invention is to provide a method that further develops a computer aided management of vehicles of a roadside car sharing program so that this method provides the largest possible user group with individual mobility at maximum efficiency of the resources employed.

The invention provides a method for the computer aided management of vehicles, which vehicles include, in each instance, both a telematic unit for transmitting predefined data to a computer system and a keyless access and start system. When the discussion in the present description focuses on vehicles, then the term “vehicles” is to be understood to mean not only vehicles with an internal combustion engine, but also electric vehicles or vehicles with a hybrid drive, i.e. a combined electric and internal combustion engine drive. Similarly the term “vehicles” may be understood to include motorcycles, bicycles, trucks and the like.

According to the method, a vehicle, which is provided by the owner for use, is registered at a management unit of the computer system as a rental vehicle, which may be used by many persons. A vehicle, which is provided by the owner for use, is, in particular, a private vehicle, i.e. a vehicle which is not owned and/or managed by a car sharing organization. The term owner is to be understood to mean, in particular, the title holder of the vehicle.

The following information is captured over a first interface of the computer system that is accessible through registration: persons, who have been approved by the owner of the vehicle, for the temporary use of the vehicle; a price model, which is specified by the owner, for the temporary use of the vehicle; an operating area, which is defined by the owner, where the operating area encompasses one or more demarcated areas, in which the vehicle may be parked by one of the approved persons after the end of the temporary use. The first interface, which is accessible through registration, can be, for example, a portal or a web site, by way of which the owner of the vehicle can enter or, respectively, store the aforementioned information. Then, corresponding information can be stored in the computer system for the vehicle of the owner.

When one of the approved persons is operating the vehicle, a data acquisition unit of the computer system receives over a telematic interface the trip related data from the telematic unit of the vehicle. Such a telematic interface is known, for example, from vehicles that are already used in the car sharing system. The telematic unit is used, in particular, to transmit the trip related data, which are determined by the telematic unit itself or with sensors and computer units associated with the telematic unit, to the computer system for billing purposes and for tracking the location of the vehicle.

Then, an accounting unit of the computer system determines, as a function of the trip related data and the price model for a predefined period of time, an amount for the temporary use of the vehicle for each approved person and bills the approved persons this amount.

The method according to the invention makes it possible to carry out car sharing in groups that are managed and organized by the owner of a vehicle. For this purpose, it is not necessary to use vehicles of a car sharing organization, but rather private vehicles, which are equipped with a telematic unit and a keyless access and start system, can be used. Since the user of the vehicle determines not only the group of persons who may use the vehicle temporarily, but also specifies an operating area, car sharing can be practiced at almost any location. As a result, it is not dependent on the operating area of commercial car sharing organizations, be they classical or roadside car sharing organizations. Since a vehicle of an owner can be used by other approved persons in periods of time, in which said owner is not using the vehicle himself, the result is a resource efficient mobility for virtually everyone, independently of the infrastructure provided by commercial car sharing providers.

According to a practical embodiment, the accounting unit of the computer system additionally determines the amount as a function of the operating area. If the vehicle is parked by one of the approved persons after the end of the temporary use within the operating area defined by the user/owner of the vehicle, then the approved person is billed an amount in conformity with the defined, fixed price model. If, however, the approved person parks the vehicle at variance with the agreement outside the operating area after the end of the temporary use, then a price that is different (likely higher) from the fixed price model may be billed. This feature is supposed to ensure that after the end of the temporary use the vehicle that is provided for joint use will be parked with a high probability within the operating area defined by the owner.

According to an additional practical embodiment, the first interface is designed to detect a change in the approved persons, the price model and/or the operating area at any point-in-time and to process this change as a basis for the billing. It can be provided that in the event of a change in the approved persons, the price model and/or the operating area, these persons will receive a commensurate message with respect to the change. Such a message can be sent automatically by the computer system to the approved persons.

Another embodiment may provide that the price model and/or the operating area that have (has) been captured over the first interface may be processed in the same way for all of the approved persons. As an alternative, it can be provided that each approved person is specifically assigned a price model and/or an operating area that has (have) been captured over the first interface. Which of the two variants will be used may be decided, preferably, by the owner of the vehicle.

In an additional embodiment the first interface is implemented in a social network in order to exchange data with the computer system. The implementation of the first interface in a social network, such as Facebook, FourSquare, Glimps, etc., enables a simple management for the owner of the vehicle. For example, he can make his vehicle accessible to friends included in the social network. Similarly there is the possibility that the owner of the vehicle may form a group inside the social network; and the participants of this group who are approved by the owner of the vehicle become or can become the approved persons for the purposes of the invention.

The management of the first interface in a social network facilitates not only the management of the approved persons, but also the calendar functions, which are made available by the computer system and which can show the availability or non-availability of the vehicle in certain periods of time, can be used via the social network. Similarly, in this context it may be possible for an approved person to reserve the vehicle for a certain period of time over the first interface in the social network. Since, as a rule, social networks are also easy to reach by Smartphones or portable computers, the result is for the approved persons a simple possibility to make, change or cancel a reservation. Similarly, it is easy to determine by way of such an interface where the vehicle concerned may be found at a specific point in time, who is in the vehicle and whether there is or is not, if desired, the possibility of spontaneously getting onboard the vehicle.

According to an additional practical embodiment, the local position of the vehicle, the route travelled, i.e. the kilometers driven with the vehicle, and a license plate number of the vehicle are collected as the trip related data for the beginning and the end of a trip by one of the approved persons and are transmitted to the data acquisition unit of the computer system. Optionally a fill state of the tank or a state of charge of the battery (SOC) can also be transmitted so that the next user (either the owner or one of the approved persons) can see whether it is necessary to fill the tank or charge the energy accumulator before the start of the trip or during the trip. The telematic unit could also be coupled in the manner known from the roadside car sharing program to a gas credit card, which can be used at the cost of the user to put gasoline in the tank of the vehicle. It can be provided that only if the gas credit card is in a reading device provided for this purpose, the vehicle can be started or the rent can be terminated. The costs incurred to pay for the fuel can be billed, for example, to the owner of the vehicle, a feature that the owner can consider in his price model.

According to another practical embodiment, an access and start token, with which the person can open, close and start the vehicle, is generated or programmed for each approved person. The access and start token can exist, for example, in the form of a chip card, which is personalized optionally by the owner of the vehicle himself or a certification office. For example, personal data of the approved person can be stored in the token during the personalizing process. The token can contain, for example, an RFID chip, which communicates with a corresponding reading device of the keyless access and start system of the vehicle in order to open and close the vehicle. The token is used in a commensurate manner to start the engine of the vehicle. Suitable access and start tokens that can be used include an RFID chip, which is issued, for example, by commercial roadside car sharing organizations, to registered users. This feature has the advantage that at the same time that the RFID chips, which are affixed to the driver's licenses of the registered users, are issued, it is also possible to check that the driver's license is valid.

According to an additional practical embodiment, the sum of the amounts determined for all of the approved persons in a predefined period of time is at least partially credited to a current account of the owner of the vehicle. As a result, the vehicle owner, who makes his vehicle available to other approved persons for joint use has a financial incentive to share his vehicle with other persons. The respective amount can be applied, for example, to the respective monthly installment payment, for example if the vehicle is financed by or leased from a manufacturer. For the operator of the computer system a percentage of the amount can be deducted for the expenses incurred in providing the infrastructure for capturing the trip related data and for the billing. Of course, other accounting models are contemplated. For example, the operator of the computer system bills the owner of the vehicle a lump sum each month. In particular, the credit is reduced by at least the operating costs, which are deducted by way of a respective token assigned to the vehicle.

The method makes it possible to set up car sharing by use of private vehicles, wherein the persons using the vehicle are billed for the use of the vehicle.

Furthermore, the invention provides a computer program product that can be loaded directly into the internal memory of a digital computer and includes software code sections, which execute the steps of the above described method, when the product runs on a computer. In this context a computer constitutes a fully automatic computing machine or a computer network of the above described computer system.

Furthermore, the invention provide a system for the computer aided management of vehicles, wherein a respective vehicle includes a telematic unit for transmitting predefined data to a computer system and a keyless access and start system. The computer system includes a management unit for registering a vehicle, which is provided by an owner for use as a rental vehicle, which can be used by many persons; a first interface, which is accessible through registration and is intended for assessing persons, who have been approved by the owner of the vehicle, for the temporary use of the vehicle; a pride model, which is specified by the owner, for the temporary use of the vehicle; and an operating area, which is defined by the owner, where the operating area encompasses one or more demarcated areas, in which the vehicle may be parked by one of the approved persons after the end of the temporary use; a data acquisition unit for processing trip related data, received over a telematic interface, from the telematic unit of the vehicle when the vehicle is operated by one of the approved persons; and an accounting unit for determining, as a function of the trip related data and the price model for a predefined period of time, an amount for the temporary use of the vehicle for each approved person and for billing the respective persons.

The system according to the invention has the same advantages, described above in conjunction with the method according to the invention. Beyond these advantages, the system can have additional components and means for carrying out the method in its embodiments.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic rendering of an exemplary inventive system for the computer aided management of the use of vehicles;

FIG. 2 is an additional schematic rendering of the system;

FIG. 3 is a schematic rendering of an exemplary first interface of the system according to the invention; and

FIG. 4 is a schematic rendering illustrating an embodiment of the inventive method for the computer aided management of the use of vehicles.

### DETAILED DESCRIPTION OF THE DRAWINGS

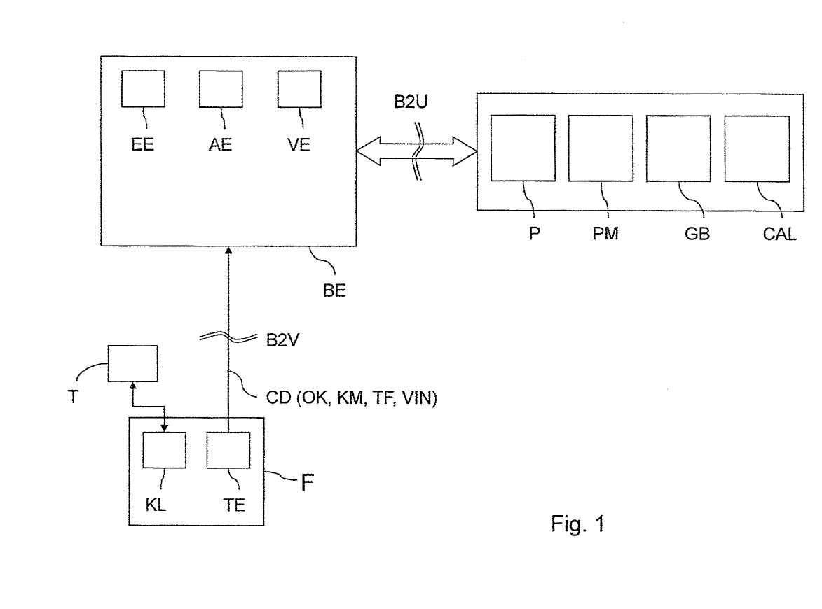

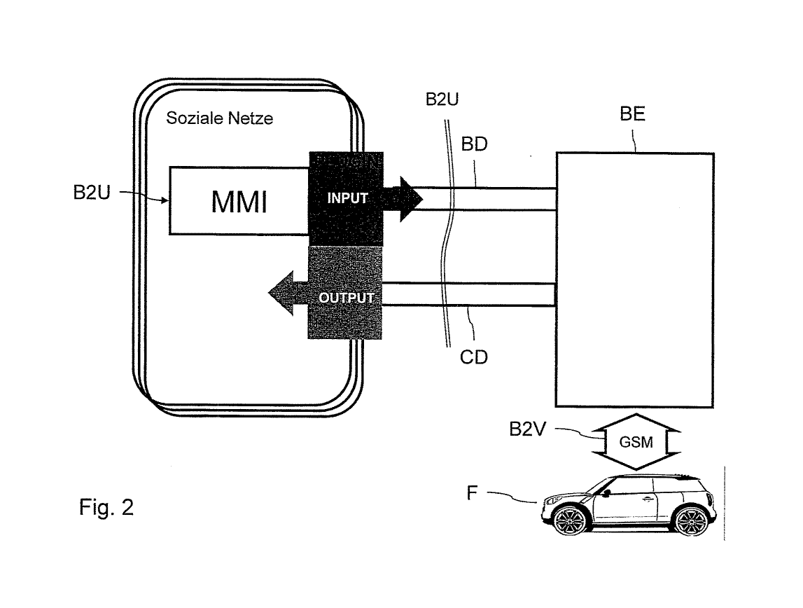

Owing to the inventive system for the computer aided management of vehicles, it is possible to make available or, respectively, to use car sharing even outside the operating area of the car sharing organizations. In order to be able to perform an accounting for those persons who are participating in the “private” car sharing program, it is necessary for a vehicle F (FIG. 2) that is used for this purpose to have a telematic unit TE and a keyless access and start system KL. Such a vehicle is shown in schematic form in FIG. 1. Optionally, the vehicle can also have a unit for a gas credit card, which generates a bill every time the owner or the persons approved to use the vehicle use the card to pay for gas. The opening and closing of the vehicle F and the starting of the vehicle F is done with a token T, which is assigned to the authorized persons. The token T can be present, for example, in the form of a chip card, a key or a simple RFID chip, which is preferably affixed to a driver's license in such a way that it cannot be detached.

The telematic unit TE is used to transmit predefined data to a computer system BE. The predefined data include trip related data for the beginning and the end of a trip by one of the persons using the vehicle. Such trip related data CD are, for example, a local position of the vehicle, the route KM that is travelled, optionally a tank content TF and a license plate number of the vehicle VIN. The data are transmitted to the computer system BE not only at the startup of the vehicle but also at the end of a trip of the vehicle for further processing.

To this extent, the above described system matches the procedure known from the roadside car sharing program. The trip related data CD are used for billing for the respective trips made by the respective persons who have been approved for the use of the vehicle concerned. In commercial roadside car sharing systems the billing or, respectively, the processing of the trip related data is performed by a service provider of the roadside car sharing program outside the computer system. For this purpose the trip related data are transmitted over an interface to said service provider.

In contrast to the commercial roadside car sharing program, the present method provides that the acquisition of the trip related data and the billing of the (approved) persons participating in the car sharing program are performed with the computer system itself. The computer system BE may be, for example, the computer system of a vehicle manufacturer, from which the user or, respectively, the owner of the vehicle F bought this vehicle, for example, by means of a financing plan, or leased the vehicle for a fixed term. Since at this point the owner or, respectively, the user of the vehicle F appears as the operator of the car sharing service, this operator sets forth over an interface B2U the general conditions to be observed for the use of the vehicle F. The registration of the vehicle F as the “private” car sharing vehicle is done over the interface B2U by means of a management unit VE.

First of all, the owner of the vehicle F approves those persons P for a temporary use of the vehicle F who are supposed to or, respectively, may participate in this temporary use. These persons are referred to as the approved persons in the description.

Additionally, the owner specifies a price model for the temporary use of the vehicle. For example, the price model can include a minute price or a price per kilometer or mile driven. Similarly, the owner of the vehicle F can decide whether the operating costs are or are not included in the use of the vehicle.

Furthermore, the owner specifies a defined operating area. In this case the operating area encompasses one or more demarcated areas, in which the vehicle may be parked by one of the approved persons after the end of the temporary use. Since the owner can define in a free and unrestricted manner the operating area, this operating area can also be established outside congested urban areas or outside the operating area of a commercial car sharing provider.

The combination of the afore-mentioned three parameters makes it possible to provide car sharing independently of commercial car sharing organizations in any area at any terms. As a result, the resources that are needed to provide and maintain a vehicle are used in the best possible way. In particular, this approach enables persons who do not have a vehicle, individual mobility, even in areas in which public transportation is insufficient.

The afore-mentioned parameters are entered over an interface B2U, which is provided by the computer system BE or preferably a plug-in of a social network. In addition to the afore-mentioned three parameters (approved persons P, price model PM and defined operating area GB), a calendar CAL, which is used to manage the joint use of the vehicle F, can be provided over the interface.

When one of the persons P approved by the owner is operating the vehicle, a data acquisition unit EE of the computer system receives over the telematic interface B2V the trip related data OK, TF, KM, VIN from the telematic unit TE of the vehicle F. An accounting unit AE of the computer system BE determines, as a function of the trip related data OK, TF, KM, VIN and the stored price model PM for a given period of time for each of the approved persons P, an amount for the temporary use of the vehicle F, and bills the persons P this amount.

If the vehicle F is leased from a manufacturer, then the amounts assigned to the persons P can be applied to the installment payments for financing or leasing. This feature gives the owner of a vehicle an incentive to make his vehicle available to other persons for joint use, because then the costs of financing or leasing can be lowered. In order to provide the technical infrastructure for acquiring the data about the trips made by the approved persons P and in order to determine the amounts due for these trips and the billing, the operator of the computer system, which is also managed preferably by the manufacturer of the vehicle, debits a lump sum or percentage amount.

FIG. 2 is another schematic rendering of the components required to implement the described method. Preferably, the interface B2U, which is necessary for organizing and managing the joint use of the vehicle F, is implemented as a plug-in in a social network. The social network, such as Facebook, FourSquare or Glimps, provides a user interface (MMI), which can be based on the familiar presentation options of the respective social network. The plug-in has a communication interface (B2U) to the computer system BE, which in turn exchanges data with the telematic unit of the vehicle F by way of the interface B2V (for example, a GSM communications link). From the computer system BE the trip related data CD are transmitted to the plug-in. The plug-in in turn transmits the reservation data BD to the computer system BE. As a result, it is ensured that, for example, a specific person P can unlock and start the vehicle only with the token of this person for the planned use of the vehicle on a day specified by the specific person and at a clock time that is also specified by the specific person. In this context the computer system BE ensures that the reservations made in the calendar CAL are properly processed. The corresponding process corresponds to the procedures and technologies known from the roadside car sharing organizations.

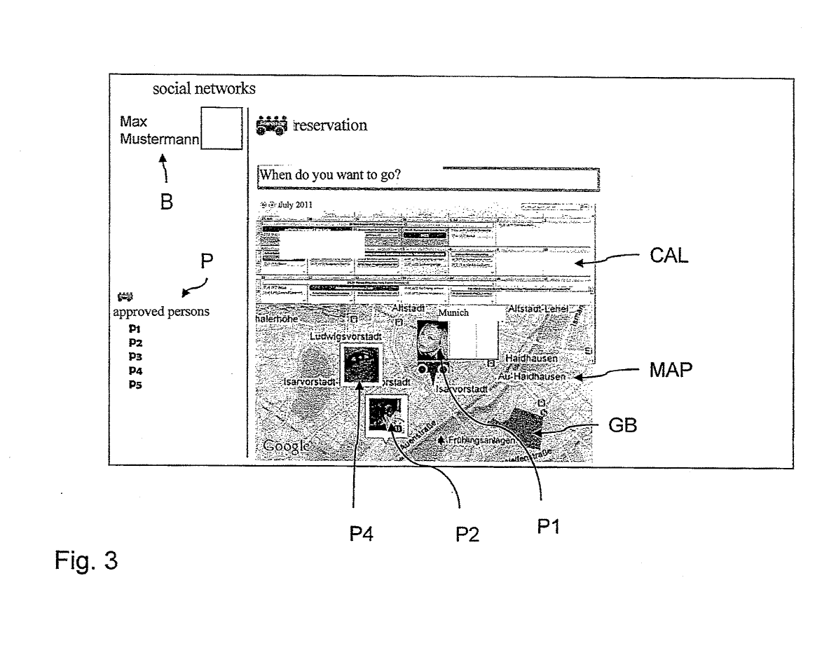

FIG. 3 is a schematic rendering of an exemplary interface B2U of a plug-in of a social network. It shows the account of the owner B of the vehicle F. This owner is marked “Max Mustermann” in the figure, where optionally a picture of the owner can be shown. The persons P, who are approved for the use of the vehicle F, are shown in the left hand region. In the illustrated example five persons P1, P2, P3, P4, P5 are approved; and they can be displayed as plain text names inside the group. The approved persons may be friends, family members and the like. The owner B does not necessarily have to be a natural person. Similarly the owner of the vehicle may be a legal person, for example a company. Then the approved persons would be the employees of the company and, if desired, other persons. As stated above, the owner B alone has control over which persons shall be approved for the use of the vehicle.

In addition, a calendar CAL is shown, and this calendar shows the approved persons and the owner at which times a reservation for the vehicle has been made and which approved person made the reservation. Similarly, the calendar CAL shows the periods in which the vehicle is available for use. In order to make a reservation, the respective approved persons enter their name on the calendar for a desired day and time. The respective data are transmitted, as stated, to the computer system BE as the reservation data BD, so that the vehicle can be unlocked (or rather started) at the respective time only by the person who has made the reservation. The purpose of this feature is to prevent the use of the vehicle at the reserved time by persons other than the person who has made the reservation. If desired, it may simply be provided that the vehicle is unlocked with an authorized token in order to remove, for example, things located therein. However, an engine startup is preferably prevented in any case.

Below the calendar CAL there is a map MAP, on which, on the one hand, the operating area GB is marked. On the other hand, the locations of those persons P1, P2, P3, P4, P5, who are approved for the use of the vehicle, are shown. For example, the map shows that the approved person P1 is using the vehicle at the present time; and that the use is located outside the operating area. This use is allowed as long as the trip is not terminated outside the operating area. If the end takes place outside the operating area, then it can be provided that the respective person is charged a monetary fine. The purpose of this strategy is to ensure that the end of the trip is almost always inside the operating area GB. Short term parking outside the operating area may be allowed, but, for example, incurs a separate fee.

The persons approved for the vehicle F can see by means of the map, for example, where the vehicle is located at the present time and make contact with the person (here: P1) using the vehicle in order, if the occasion may arise, to get spontaneously onboard.

In principle, embodiments other than those illustrated here are also contemplated. In particular, it is not mandatory that the interface for managing and reserving the vehicle be implemented in a social network. For example, a dedicated platform may also be provided by the operator of the computer system for this purpose.

Similarly, it is possible that the management is performed by use of an App of a computer or a Smartphone.

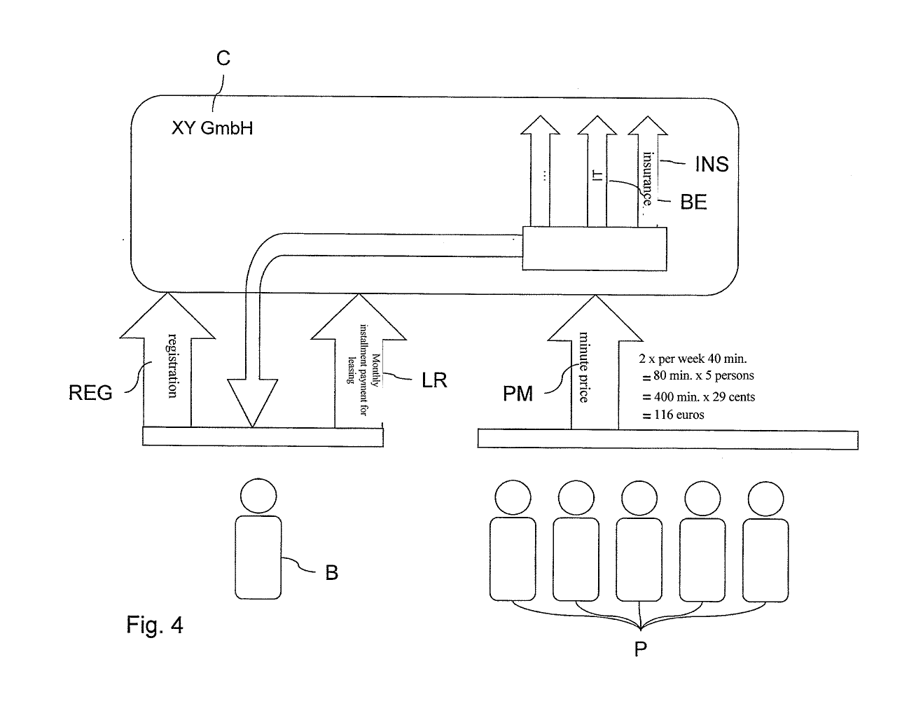

FIG. 4 illustrates in schematic form the interplay of the stages involved in the method according to the invention. The reference letter C marks a service provider (“XY GmbH”), which provides the computer system BE, the contracts required for the use and the insurance policies INS. The owner B of the vehicle has to register REG at this service provider C and optionally pay the service provider C a rental fee or leasing fee LR each month. The service provider C may be the manufacturer of the vehicle or a company that owns the vehicle. The registration of the approved persons P also takes place at C. Since C collects and evaluates all of the information about the trip related data as the operator of the computer system, C can calculate a price for the use of the vehicle by the approved persons P with the price model PM specified by the user B. For example, the price model can include a “minute price.” In the exemplary embodiment depicted in FIG. 4, the share of an approved person P is 40 minutes of use twice per week. Thus, the result is a use period of 400 minutes for all five approved persons. At a minute price of 29 cents the result is a credit of 116 euros in favor of the owner B. This credit can be applied, for example, to the user's monthly installment payment for leasing LR of the vehicle. The approved persons may be billed, for example, directly by the service provider C for the use of the vehicle F. Similarly, other models may also be used.

The method according to the invention has the advantage that customers with their private vehicle, which is financed, for example, over a fixed period of time or leased for a fixed period of time, may set up with this vehicle their own car sharing system for a user group that they themselves define. In this case a social network is used preferably as the organization platform. For the manufacturer of the vehicle the range of the car sharing fleet is significantly increased by setting up “private car sharing providers.”

### LIST OF REFERENCE NUMERALS AND LETTERS

F vehicle
B owner
T token (RFID transponder)
TE telematic unit
KL access and start unit (possibly with a gas credit card)
P approved person
P1 approved person
P2 approved person
P3 approved person
P4 approved person
P5 approved person
PM price model
GB operating area
CAL calendar
BE computer system
AE accounting unit
EE data acquisition unit
VE management unit
CD vehicle data and/or trip related data
B2V telematic interface
B2U first interface
MMI interface
BD reservation data
MAP map
INS insurance
REG registration
LR installment payment for leasing

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for computer aided management of vehicles, each vehicle being equipped with a keyless access and start system and a telematic unit that transmits predefined data, the method comprising the acts of:
receiving, in a computer system, registration information for a vehicle, provided by an owner, for use as a rental vehicle by one or more persons;
receiving, in the computer system via a first interface, information including:
persons, approved by the owner of the vehicle, for a temporary use of the vehicle;
a price model, specified by the owner, for the temporary use of the vehicle; and
an operating area, defined by the owner, the operating area encompassing one or more demarcated areas in which the vehicle is to be parked by an approved person after ending the temporary use of the vehicle;
receiving, in the computer system, trip related data from the telematic unit of the vehicle when an approved person is operating the vehicle;
determining, in the computer system, a billable amount for the temporary use of the vehicle as a function of the trip related data and the price model for a predefined period of time for the approved person using the vehicle.

2. The method according to claim 1, wherein the determining of the billable amount determines the billable amount also as a function of the operating area.

3. The method according to claim 1, wherein the receiving of the registration information in the computer system is carried out via an interface of the computer system.

4. The method according to claim 1, wherein the first interface is operatively configured to detect changes in at least one of the approved persons, the price model and the operating area at any point-in-time, the changes being utilized in determining the billable amount.

5. The method according to claim 1, wherein at least one of the price model and the operating area received via the first interface are processed in a same way for all approved persons.

6. The method according to claim 4, wherein at least one of the price model and the operating area received via the first interface are processed in a same way for all approved persons.

7. The method according to claim 1, wherein at least one of the price model and the operating area received via the first interface are assigned specifically to each approved person.

8. The method according to claim 4, wherein at least one of the price model and the operating area received via the first interface are assigned specifically to each approved person.

9. The method according to claim 1, wherein the first interface of the computer system is operatively configurable for a social network through which data is exchangeable with the computer system.

10. The method according to claim 1, wherein the received trip related data comprises a local position of the vehicle, a route traveled, and a license plate number for a beginning and an end of a trip by the approved person using the vehicle.

11. The method according to claim 1, further comprising the act of:
generating, for each approved person, an access and start token with which the respective approved person may open, close and start the vehicle.

12. The method according to claim 1, further comprising the act of:
at least partially crediting to a current account of the owner of the vehicle a sum of the billable amounts determined for all of the approved persons in a predefined period of time.

13. The method according to claim 12, further comprising the act of:
reducing the at partially credited sum to account for at least operating costs deducted by way of a respective token assigned to the vehicle.

14. A computer product, comprising:
a computer readable medium loaded directly into an internal memory of a computer system, the computer readable medium comprising program code sections that:
receive, in the computer system, registration information for a vehicle, provided by an owner, for use as a rental vehicle by one or more persons;
receive, in the computer system via a first interface, information including:
persons, approved by the owner of the vehicle, for a temporary use of the vehicle;
a price model, specified by the owner, for the temporary use of the vehicle; and
an operating area, defined by the owner, the operating area encompassing one or more demarcated areas in which the vehicle is to be parked by an approved person after ending the temporary use of the vehicle;
receive, in the computer system, trip related data from the telematic unit of the vehicle when an approved person is operating the vehicle; and
determine, in the computer system, a billable amount for the temporary use of the vehicle as a function of the trip related data and the price model for a predefined period of time for the approved person using the vehicle.

15. A system for computer aided management of vehicles, each vehicle comprising a keyless access and start system and a telematic unit that transmits predefined data, the system comprising:
a computer system operatively configured to receive the predefined data and to interact via a first interface; and
wherein the computer system comprises:
a management unit that registers a vehicle provided by an owner for use as a rental vehicle usable by one or more persons, wherein the first interface is operatively configured to capture:
persons, approved by the owner of the vehicle, for a temporary use of the vehicle;
a price model, specified by the owner of the vehicle, for the temporary use of the vehicle; and
an operating area, defined by the owner of the vehicle, wherein the operating area encompasses one or more demarcated areas, in which the vehicle is to be parked by an approved person after an end of the temporary use of the vehicle by the approved person;
a data acquisition unit operatively configured to process trip related data received over a telematic interface from the telematic unit of the vehicle when the vehicle is being operated by an approved person; and
an accounting unit operatively configured to determine, as a function of the trip related data and the price model for a predefined period of time, a billable amount for the approved person that temporarily used the vehicle.
